(19) United States
(12) Patent Application Publication
(10) Pub. No.: US 2018/0180753 A1
(43) Pub. Date: Jun. 28, 2018

(54) SYSTEM AND METHOD FOR MEASURING IN-GROUND VIBRATION

(71) Applicant: FUTURE FIBRE TECHNOLOGIES PTY LTD, Mulgrave, Victoria (AU)

(72) Inventors: Pathmanathan Rajeev, Aspendale Gardens, Victoria (AU); Seedahmed S. Mahmoud, Dandenong, Victoria (AU); Bernhard G. Koziol, Ringwood, Victoria (AU); Frederick Davis, Canterbury, Victoria (AU); Jay G. Sanjayan, Glen Waverley, Victoria (AU); Piratheepan Jegatheesan, Noble Park North, Victoria (AU)

(21) Appl. No.: 15/578,911

(22) PCT Filed: Jun. 3, 2016
(86) PCT No.: PCT/AU2016/050456

§ 371 Date: Dec. 1, 2017

(30) Foreign Application Priority Data
Jun. 4, 2015 (AU) 2015902202

(51) Int. Cl. G01V 1/22; G02B 6/50

(52) U.S. Cl. CPC G01V 1/226; G02B 6/504

(57) ABSTRACT

The present invention provides a method of installing a fibre optic cable for measuring in-ground vibration. The method comprises attaching the fibre optic cable to an external wall of a resilient support member having at least one cavity therein, and burying the fibre optic cable and the support member.

### FIELD OF THE INVENTION

The present invention relates to a method for installing fibre optic cables and to a system and a method for measuring in-ground vibration.

### BACKGROUND

Sensing systems using buried optic fibres have been deployed to sites to monitor for intrusions. In such systems a buried fibre optic sensing cable is used for monitoring and detecting in-ground acoustic and seismic waves that generate minute displacement created by third-party intrusions such as human walking, crawling, running, digging, and local vehicle movement both on road and off. However, the soil surrounding the cable can also dampen these vibrations resulting in degraded performance.

Due to the very complex structure of soil mass, the damping property significantly depends on the soil types. Soil consists of an assemblage of solid particles with different sizes and shapes that form a skeleton and their voids are filled with water and gas or air. Petrophysical and lithological properties such as porosity, degree of saturation and clay content have a marked impact on acoustic and vibrational wave propagation properties of soils and rocks.

A number of techniques have been proposed to improve the sensitivity of buried ground sensors when an intruder is walking above it. In one prior technique, a fibre optic sensor is woven into a mesh and buried to ensure that the intruder steps on the ground above the fibre. This method has a number of drawbacks including: (1) it is not possible to make sure during backfilling that there is room for the fibre to deform or repose to respond to an intrusion; (2) as the backfill soil consolidates and compacts over time, this reduces the pore space and consequently reduces/stops the response of the mesh and fibre (i.e., the mesh and fibre system gets “locked” in the ground; and (3) the situation can be worse in locations with clay backfill and frequent rainfall, where wetted backfill gets harder and prevents the mesh from moving or deforming.

There is a need for an alternative buried optical fibre intrusion detection system.

### SUMMARY OF INVENTION

In a first aspect, the invention provides a method of installing a fibre optic cable for measuring in-ground vibration, the method comprising:
attaching the fibre optic cable to an external wall of a resilient support member having at least one cavity therein, and
burying the fibre optic cable and the support member.

In an embodiment, the resilient support member may be a conduit and attaching the fibre optic cable to an external wall of the conduit may comprises clamping the fibre optic cable to the resilient conduit by means of clips.

In an embodiment, the method may further comprise pegging the resilient conduit to the ground through holes formed in the clips.

In an embodiment, the method comprises burying the fibre optic cable and the support member so that the fibre optic cable is positioned above the support member.

In an embodiment, the method may also comprise closing the conduit at both ends to avoid fluid and/or fine particle infiltration.

In an embodiment, burying comprises laying the fibre optic cable and the support member in the ground to form a winding path.

In a second aspect, the present invention provides an apparatus for measuring in-ground vibration comprising:
a resilient support member having at least one cavity therein;
fibre optic cable attached to an external wall of the support member; and
a sensing unit for propagating light into the fibre optic cable, analysing the backscattered light from the fibre optic cable, and processing variations in the backscattered light to detect external movements.

In an embodiment, the support member may be made of soft PVC. In an embodiment, the support member may be a conduit.

In an embodiment the conduit is a tube of cylindrical shape. In an embodiment, the diameter of the cylindrical tube may be between 15 mm to 50 mm.

In an embodiment, the conduit is a tube of rectangular shape. In an embodiment, the height of the rectangular tube may be between 20 mm to 50 mm and the width of the tube is between 100 mm and 300 mm.

In an embodiment, the conduit is a tube of elliptical shape. In an embodiment, the minor axis of a cross-section of the elliptical tube has a length between from 20 mm and 50 mm and the major axis of the cross-section of the elliptical tube has a length between 75 mm and 300 mm.

In an embodiment, the sensing unit may comprise a phase-sensitive Optical Time Domain Reflectometer (OTDR) for light propagation in the fibre optic cable and analysis of light exiting the fibre optic cable.

In a third aspect, the invention provides a method for measuring in-ground vibration comprising:
propagating light into fibre optic cable attached to a resilient support member having at least one cavity therein,
analysing the backscattered light from the fibre optic cable, and
processing variations in the backscattered light to detect external movements.

The resilient support member may be a conduit.

In an embodiment, propagating light comprises emitting light from a laser source and directing the light in the fibre optic cable.

In an embodiment, propagating light may further comprise dividing the sensing cable length into a series of bins that have a width that is determined by a sampling rate of the controller.

In an embodiment, analysing the backscattered light may comprises analysing the backscattered light from each of the series of bins.

In an embodiment, processing variations in the backscattered light comprises, analysing the backscattered light to determine whether it contains any pattern that is a result of third party intrusion.

In an embodiment, the method may further comprise determining the location along the fibre optic cable of any pattern that is a result of third party intrusion.

### BRIEF DESCRIPTION OF THE DRAWINGS

In order that the invention may be more clearly ascertained, embodiments will now be described, by way of example, with reference to the accompanying drawing, in which:

FIG. 1 is a schematic diagram of an apparatus according to an embodiment of the present invention;

FIGS. 2A, 2B and 2C show an example of a clip for securing the optical fibre sensor on the conduit;

FIG. 3 is a photo of the clip shown in FIGS. 2A, 2B and 2C.

FIG. 4A is a schematic end view diagram of the apparatus of FIG. 1 buried in the ground;

FIG. 4B is a schematic side view diagram corresponding to FIG. 4A;

FIG. 5A is a schematic end view diagram of a prior art fibre optic sensing cable buried in the ground;

FIG. 5B is a schematic side view diagram corresponding to FIG. 5A;

FIG. 6A is a schematic diagram of a standard ‘dolphin-tail’ pattern configuration;

FIG. 6B shows a portion of the ‘dolphin-tail’ pattern of FIG. 6A;

FIG. 7 is a schematic diagram of an optical configuration for the test bed;

FIG. 8 is a diagram of the signal average intensity against the parallel distance from a shallow buried sensor with and without the conduit;

FIG. 9 is space-time representation of 7 footfalls of a person walking on top of the sensor laying above a tube the conduit; and

FIG. 10 is a space-time representation of 7 footfalls of a person walking on top of the sensor without the conduit.

### DETAILED DESCRIPTION

Buried fibre-optic intrusion detection systems of embodiments of the invention analyse changes in the propagation of light in fibre optic cable buried in the ground. The light signal is affected by external movement caused by, for example, human steps. In time the soil around the buried fibre optic cable tend to compact causing a reduction of the sensitivity of the optic sensor to in-ground movements. Thus, embodiments of the application have particular, but not exclusive, application to security systems to protect perimeters, country borders, pipelines and data/communications networks from intrusion, excavation, theft, terrorism or espionage activities.

Embodiments of the present invention employ an advantageous method of installing a fibre optic cable for measuring in-ground vibration. The method includes attaching the fibre optic cable 120 to an external wall of a resilient support member having at least one cavity therein. In an embodiment, the resilient support member is a resilient conduit 180. The method of the embodiment involves burying the fibre optic cable 120 and the conduit 180. In this way, vibrations of the flexible conduit 180 in response to external movements are transferred to the sensor cable 120 enhancing the sensitivity of the intrusion detection system 100.

In an embodiment, the fibre optic cable 120 is attached to the upper surface of the conduit so that, when the fibre optical cable 120 and conduit 180 are buried, the fibre optical cable 120 is closest to the surface of the ground. In other embodiments, the fibre optic cable, however, could be located on a different part of the external surface of the conduit 180.

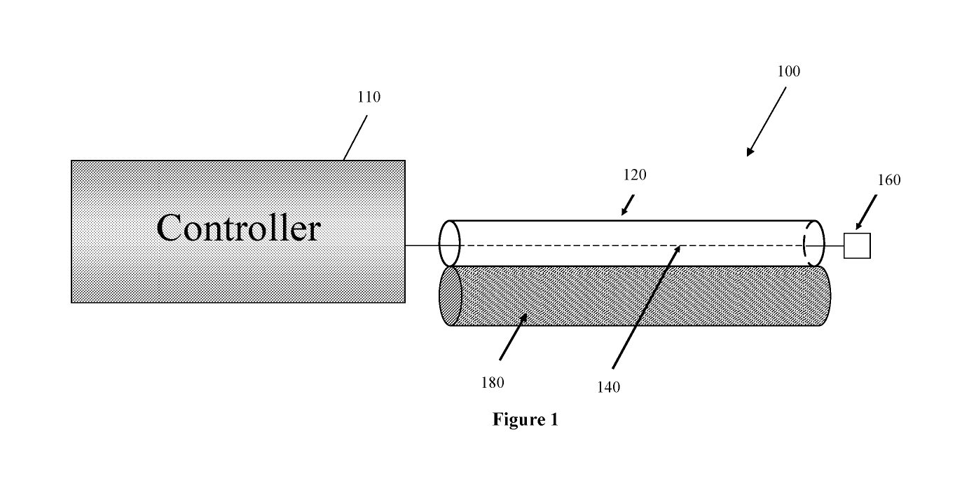

Optical fibre cable sensors have the advantage of immunity to RF and EM interference and require no power in the field during operation. The fibre optic intrusion detection apparatus 100 according to an embodiment is schematically represented in FIG. 1 and includes a controller 110, a fibre optic sensing cable 120, a sensor fibre 140 and an end sensor 160.

Controller 110 may be, for example, an FFT Aura controller available from Future Fibre Technologies Ltd (www.fftsecurity.com). In an embodiment, controller 110 uses Phase-sensitive Optical Time Domain Reflectometer (OTDR) technology to detect acoustic and seismic energy that imparts a minute displacement on the sensor cable 120. The controller 110 is a phase sensitive OTDR and is very sensitive to low frequencies and requires access only to one end of a single mode optical fibre to operate. Other fibre-optic sensing technologies such as phase interferometry can also be utilized to perform the sensing. For example, in other embodiments Michelson or Mach-Zehnder (MZ) interferometers may be employed.

In an embodiment, the sensor cable is attached to a flexible conduit 180 made of PVC. The conduit can also be made of other materials, such as nylon, rubber or a polyethylene material.

In one example, the conduit 180 is a high density polyethylene (HDPE) hose. The conduit 180 deforms when a load is applied to it directly or locally, the deformation displacing the fibre cable 120 thereby creating an event. As the conduit should be flexible enough to deform for small forces, it is preferable to use a relatively small diameter conduit 180. The ends of the conduit are closed with end caps to block water and any fine soil particle ingress. In some embodiments joiners may be used to join sections of conduit or sections of conduit may be closed with end caps and attached to neigbouring sections.

Soft PVC is particularly suitable for its material properties, which are as follows.
Material behaviour is elastic in a small stress range: the conduit keeps the same shape after subjected to small stresses.
Fracture strength is high: the possibility for crack initiation during compaction or loading is low.
Good corrosive resistance.

Rubber is another suitable material and has the further advantageous property of retaining elasticity over wide temperature range. In other embodiments, materials with similar characteristics could be used for the conduit 180.

In an embodiment the conduit 180 is made of soft PVC with an elastic modulus of between 400 to 1000 MPa. In another embodiment conduit 180 can be made of low density polyethylene (LDPE) or high density polyethylene (HDPE).

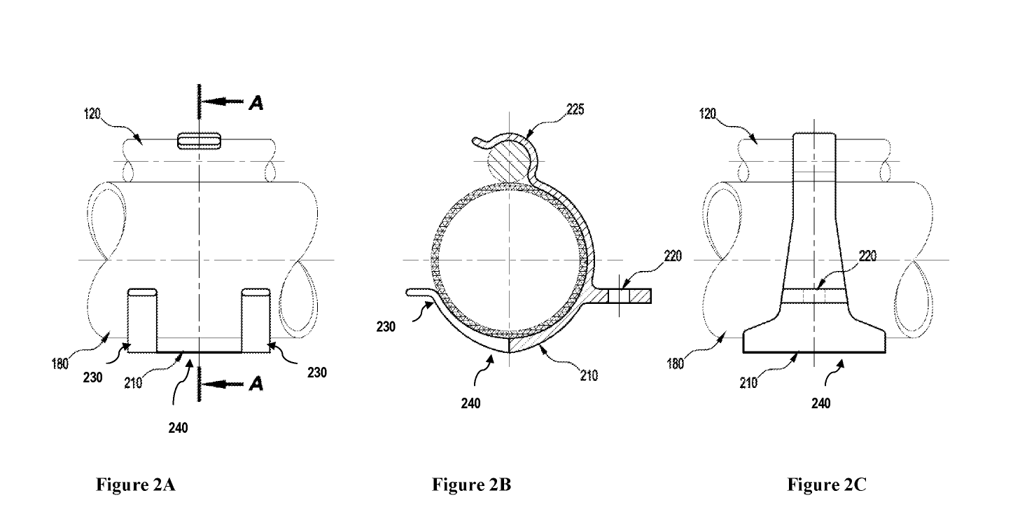

The conduit 180 can be of cylindrical shape, as shown in the FIG. 2B, with a diameter of 15 mm to 50 mm. In one embodiment, the diameter is approximately 29 mm. In another embodiment, the diameter is approximately 25 mm

It should be appreciated that in other embodiments, the conduit may be formed in different shapes and dimensions. In some embodiments the conduit has an elliptical cross-section. The minor axis of the cross-section of the conduit has a length between from 20 mm and 50 mm and the major axis of the cross-section of the conduit has a length between 75 mm and 300 mm.

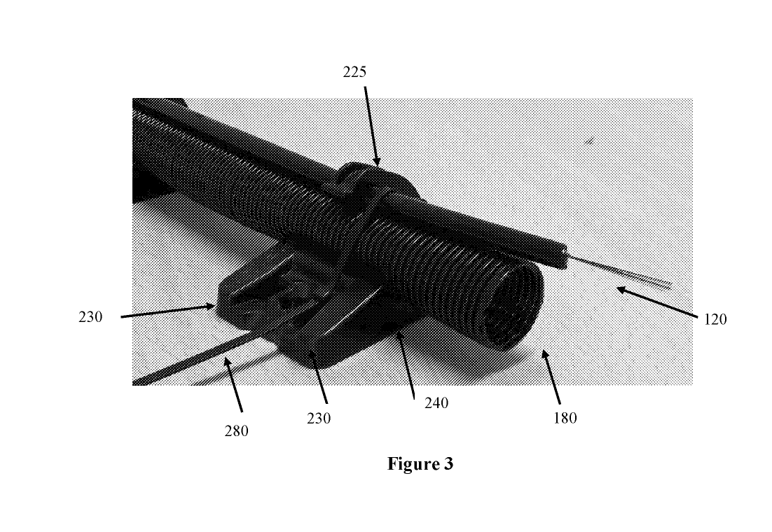

In an embodiment, the conduit 180 and the sensor cable 120 are attached by clamping means in the form of the clips 210 shown in more detail in FIGS. 2A, 2B and 2C and 3. The spacing between the clips is chosen to keep the cable secured to the tube, while still maintaining the flexibility of the tube. If the spacing is too short, the sensor cable is unable to move, and if the spacing is too long the sensor cable may slip off the conduit. In both cases the sensitivity of the sensor cable is reduced. The clips, for example, may be spaced one metre apart.

The clips 210 attach to the conduit 180 and each have a retainer 225 for securing the cable sensor 120 to the conduit 180.

The clips further comprise a bottom end 240 opposite to the retainer and generally wider than the retainer to accommodate the conduit 180. In the embodiment shown in FIGS. 2A, 2B and 2C the bottom end 240 includes two fingers 230 symmetrically spaced apart from the centreline (A-A) of the clip.

In some embodiments the fingers 230 are asymmetrically spaced apart from the centreline of the clip. In some other embodiment the clip comprise only one finger 230 and in yet other embodiments the clip comprise more than two fingers.

The clips 210 further comprise a hole 220 through which a peg can be inserted in order to peg the conduit 180 (and hence the cable) to the ground.

The method of clipping provides efficient coupling between cable and the conduit surfaces without inhibiting the flexibility or deformation of the conduit. Additionally, the clips are easily adjustable so that the spacing between attachment points can be easily changed according to the abovementioned requirements.

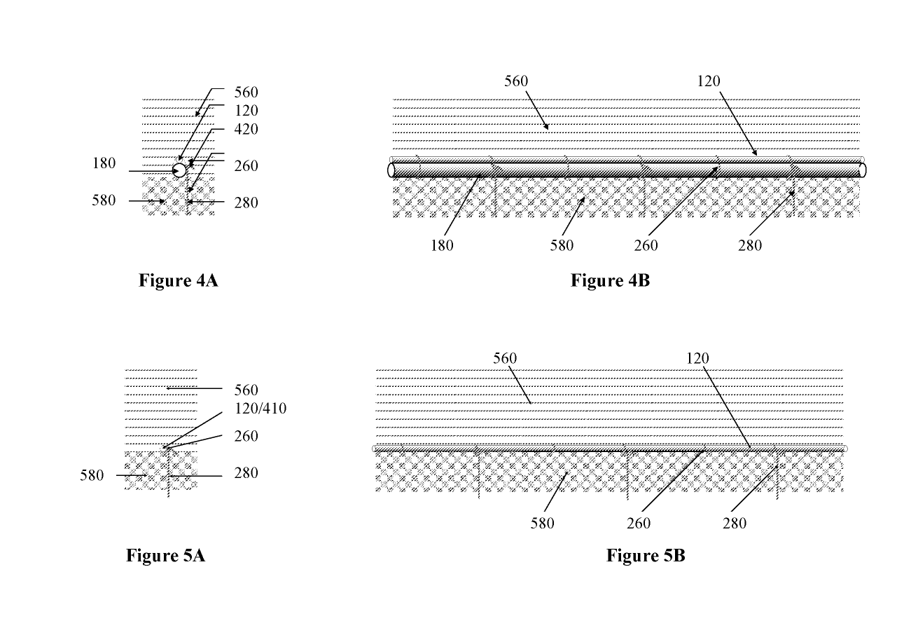

In an alternative embodiment, the conduit 180 and the cable 120 can be attached by cable ties as shown in the experimental arrangement of FIGS. 4A and 4B.

In another embodiment, the resilient support member can be an air mattress or a larger air bladder to increase the sensor area.

There are several advantages of employing a resilient support member, such as a conduit, in combination with a fibre optical cable 120 for measuring in-ground movements.

First the conduit creates a permanent air-filled space that can allow the fibre sensor cable 120 to deform during intrusion.

Second, the air-filled space within the conduit remains the same or nearly same as in the installation stage regardless of backfill compaction overtime. This will keep the performance of the sensor cable 120 consistent over a long period of time.

Third, fibre performance is not affected by climate as the ends of the conduit are closed with end caps to block water ingress and retain the air-filled space.

In some embodiments, rather than being laid in a straight line, the sensor cable 120 may be laid in other configurations, for example, in a winding path such as an s-shape, ‘dolphin tail’ or a serpentine path.

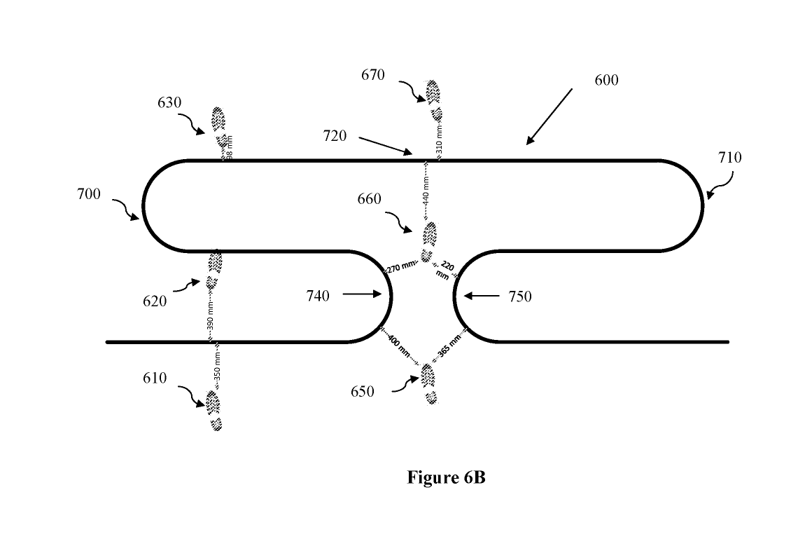

Whilst a number of cable patterns can be used to increase the probability of detecting a walker in a covert buried sensing system, a ‘dolphin-tail’ pattern 600 as illustrated in FIG. 6, optimizes the probability of detecting a footfall against the amount of cable needed per metre of perimeter.

Advantageously, the ‘dolphin tail’ configuration 600 provides greater length of sensing cable close to each foot-fall/disturbance, which in turns allows for detections of stealthy walking or crawling intrusion and improves detection in difficult soil conditions (eg sandy and compacted clay). In some embodiment the sensing system is modify to detect several footfalls before signaling an intrusion to avoid excessive nuisance alarms.

The dimensions of the ‘dolphin tail’ pattern are tailored to the characteristics of the soil where the cable is installed. FIG. 6A shows the dimensions of a standard ‘dolphin tail’ pattern cable installed in a type of soil that efficiently transfers intrusion signals (i.e. loamy soil, gravel).

This standard pattern has a width of 1.3 m. One cycle, i.e. the distance between two equivalent points 840, 860 in two adjacent dolphin tails, is 4.70 m, while the distance between two adjacent tails 840, 850 and/or the distance between two adjacent mirrored folded portions 740, 750 of the cable is 0.43 m.

In areas where the native soil type attenuates intrusion signals (i.e. solid hard clay) a wider pattern, of, for example, 1.7 m width, is preferable. The other dimensions of the cable pattern are the same of the standard pattern. In some embodiments the cycle length and/or the distance between two adjacent mirrored folded portions 740, 750 is also varied to account for the soil signal transmission efficiency.

As shown in FIG. 6B in the standard ‘dolphin tail’ configuration 600 (as described above), the sensor-tube is buried in the ground in such a way that, when an intruder walks perpendicularly across the secured area, any given footfall will be within 400 mm from the sensor-tube cable configuration. The dolphin tail is formed from a left-side s-shaped cable pattern which continues in a mirror image cable pattern 710 on the right-side of FIG. 6B.

The left side of FIG. 6B shows an example of an intruder walking perpendicularly across and on top of one of the two cable patterns 700, 710. The distance between the footfalls 610, 620, 630 and the closest part of the buried cable is respectively 350 mm, 390 mm and 98 mm.

The central part of FIG. 6B shows an example of an intruder walking on top of the space between the two folded portions 740, 750 and on top of the segment 720 where the s-shape cable pattern flips to the mirrored s-shape cable pattern 710. Upon entry into the secured area the distance between the first footfall 650 and the two folded portions 740, 750 of the cable is respectively 400 mm and 365 mm. When the intruder further steps across to the second position 660, the distance between the footfall and the the two folded portions 740, 750 of the cable is respectively 270 mm and 220 mm, while the distance to the the segment 720 where the s-shape cable pattern flips to the reversed s-shape cable pattern is 440 mm. Finally, as the intruder steps to the third position 670 outside the ‘dolphin tale’ configuration 600 the distance between the footfall and the closest portion of the buried cable is 310 mm.

Therefore any given footfall will be within 400 mm from the sensor-tube cable configuration.

In some embodiments the s-shape configurations 700, 710 are differently proportioned and are not symmetrically spaced apart.

With reference to FIG. 1 a method for measuring in-ground vibration provided by the present invention includes propagating light into the buried fibre optic cable 120 attached to the resilient conduit 180, analysing the backscattered light from the fibre optic cable, and processing variation in the backscattered light to detect external movements. Propagation and control of the light in the cable sensor 120 is performed by a sensing unit which includes a controller 110. As indicated above the controller may employ phase sensitive OTDR.

Phase-sensitive OTDR uses the conventional OTDR principle in that a pulse of light propagates along a fibre optic sensor 120. The light source (not shown) is a laser source that has a relatively high coherence. As the pulse propagates part of its energy is back-reflected due to Rayleigh backscatter effects. This effectively sets up a sequential array of interferometers or “microphones” along the sensing cable 120. An end sensor 160 terminates the distal end of the fibre sensor, and a photodetector in the controller 110, is used to measure the backscattered intensity to monitor the response of each interferometer. Whenever an external event occurs on the sensing cable 120 the backscatter energy at the point of intrusion changes and can be detected by the system 100.

The controller 110 divides the sensing cable 120 length into a series of bins that have a width that is determined by its sampling rate. Software within the controller is able to analyses each bin and look for patterns that are a result of third party intrusion and reveal its location along the sensor cable 120.

Experimental Results

In order to demonstrate advantages of the system and method of the embodiment, a performance comparison was conducted using intrusion detection systems with and without a conduit attached to the optical fibre sensor.

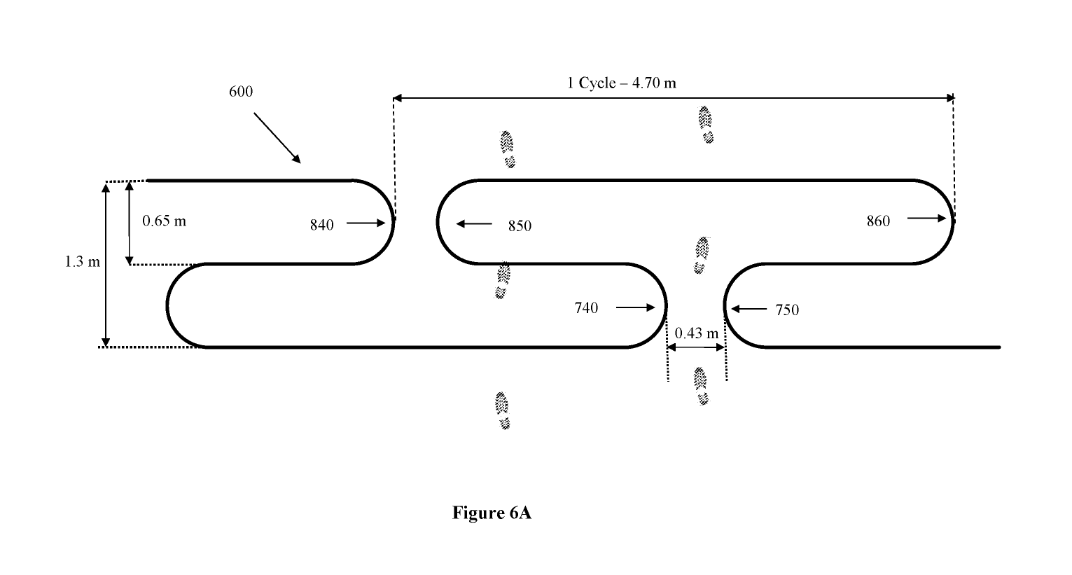

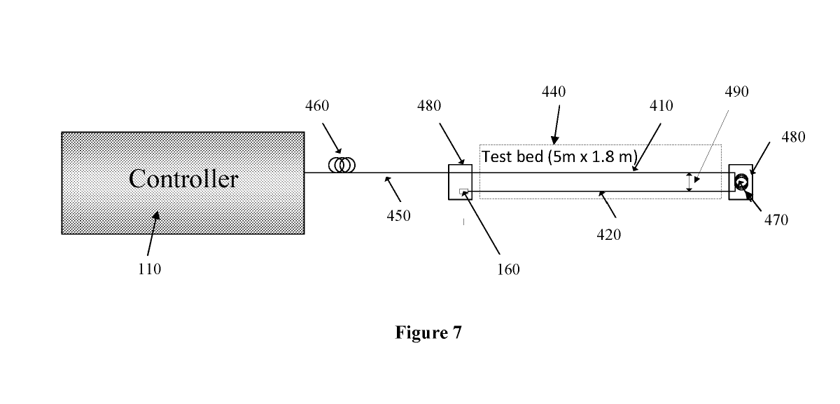

A test bed 440 was set up for experimental observation as shown in FIGS. 4A to 5B and in FIG. 7.

A pad (5×1.8 m) was scraped to a depth of 175±50 mm forming a scrape base 580. Two passes of 12 fibre loose tube single mode cable (AFL cable: FQHU1CEW012BK) were installed separated by a 200 mm spacing 490. The first pass 410 was pegged every 1 m directly to the ground, as shown in FIGS. 5A and 5B, the second cable 420 was tied to a 19 mm diameter soft PVC tube using cable ties and was also pegged to the ground at 1 m intervals as shown in FIGS. 4A and 4B. The trench was backfilled to a depth of 100 mm with the same material that was disturbed during the scraping process and lightly compacted forming a backfill area 560. The remainder of the backfill soil was spread on top and compacted lightly again to return the test bed to the same level as the surrounding soil (175 mm).

Implementation of the proposed configuration will now be described with reference to FIGS. 4A to 5B and FIG. 7.

A FFT Aura controller 110 was connected to the fibre optic system. The optical system comprised of three main sections, a sensitive lead-in 450 to the test bed 440, the sensor cable 120 within the test bed and the end sensor 160 at the far end of the sensing cable.

The entire fibre optic length that the pulse propagates is inherently sensitive to vibration, therefore it is imperative that the exact location of each sensor run for the intrusion measurement is known and the fibre length up to the start of the sensor run can be ignored through software.

The test area has two sensors 410, 420 that are optically coupled in series but are located in parallel with a 200 mm separation 490 as shown in FIG. 7. The first sensor 410 has the sensor pegged directly to the ground (see FIGS. 5A and 5B), the second sensor has been cable-tied to a 19 mm soft PVC hose 180 and also pegged to the ground (see FIGS. 4A and 4B). A 20 m buffer cable 470 was used to provide optical isolation between these two sensor portions.

An end sensor 160 is used to ensure that the pulse is decoupled from the sensor efficiently, otherwise a large reflection will result, obscuring the final 20 m of the sensor.

Both the buffer cable and end sensor were located in buried pits 480.

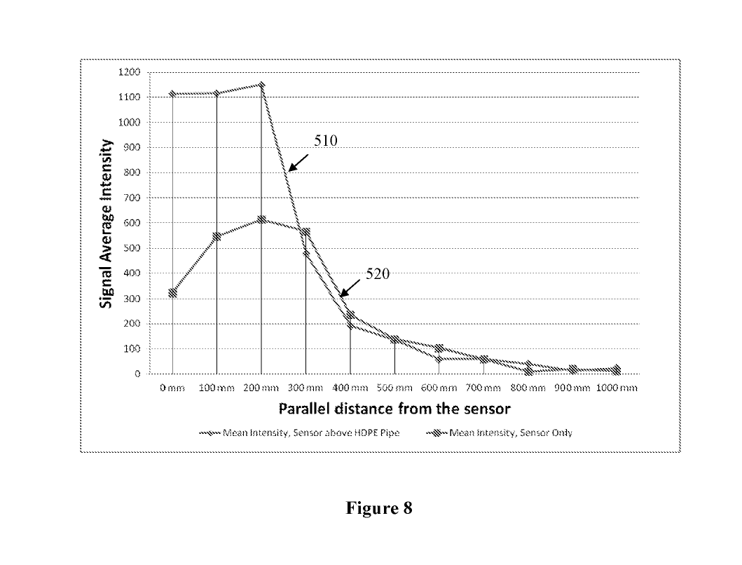

A number of tests were conducted to measure the sensitivity of fibre cable 120 attached to a conduit 180 in accordance to the present invention versus the sensitivity of the same fibre cable buried directly in a compacted soil medium. These tests were conducted using an intruder of 85 kg mass walking simultaneously parallel to these sensors at different locations (0 mm (top of the sensor), 100 mm, 200 mm, 300 mm, 400 mm, 500 mm, 600 mm, 700 mm and 800 mm) from the sensors. Average signal intensity was measured for each sensor at these locations and the results are plotted in FIGS. 8 to 10.

FIG. 8 shows the detected signal average intensity versus the parallel distance from the sensor caused by a 85 kg intruder walking parallel and above an to a shallow buried sensor with 510 and without 520 a soft PVC tube. The result in FIG. 8 indicates that attaching the sensor laying above and attached to a tube of soft PVC amplifies the signal of an intruder that is either directly above or within 200 mm either side of the sensor.

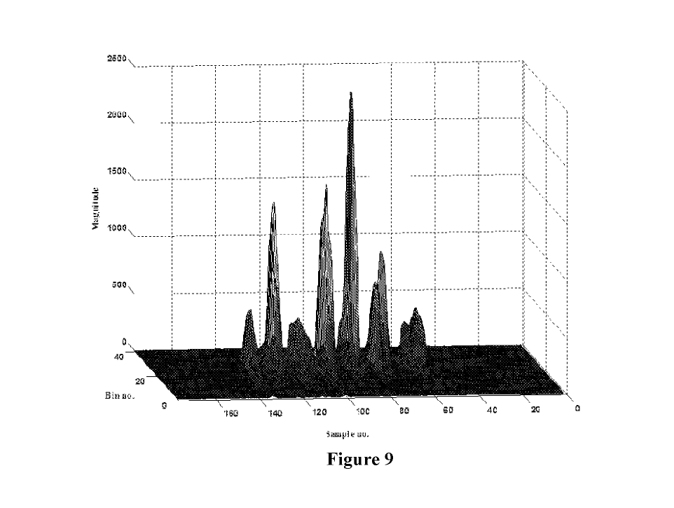

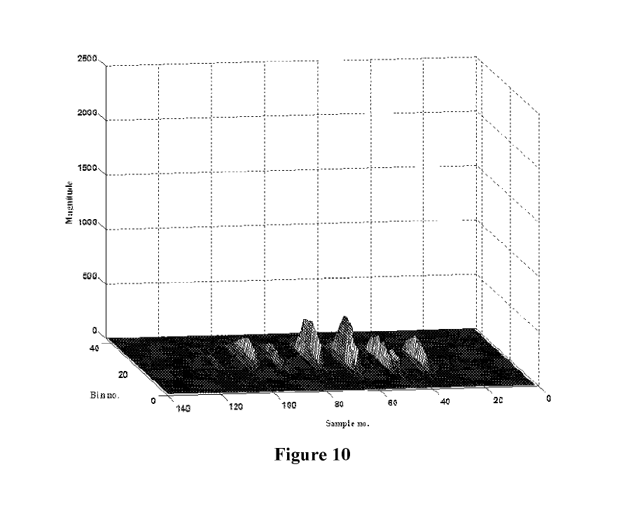

FIGS. 9 and 10 show space-time representation of seven footfalls of a person walking on top of the sensor laying above a tube of soft PVC (FIG. 9) and the sensor without the soft PVC tube (FIG. 10). Both sensors were able to detect all footfalls, however, the sensor attached to the soft PVC tube has superior magnitude intensity when compared to the sensor not attached to the soft PVC tube.

In conclusion the system and the method provided by the present invention significantly increases/amplifies the coupling between the third-party intrusion and the buried sensor cable.

There may be other modifications to the embodiments, for example, in on embodiment the resilient support member and the optical fibre could be attached during a manufacturing process and installed as a unitary member.

It is to be understood that, if any prior art is referred to herein, such reference does not constitute an admission that such prior art forms a part of the common general knowledge in the art, in Australia or any other country.

In the claims that follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method of installing a fibre optic cable for measuring in-ground vibration, the method comprising:
attaching the fibre optic cable to an external wall of a resilient support member having at least one cavity therein, and
burying the fibre optic cable and the support member.

2. The method of claim 1, wherein the resilient support member is a conduit.

3. The method of claim 2, wherein attaching the fibre optic cable to an external wall of the conduit comprises clamping the fibre optic cable to the resilient conduit by means of clips.

4. The method of claim 3 further comprising pegging the resilient conduit to the ground through holes formed in the clips.

5. The method of claim 1 comprising burying the fibre optic cable and the support member so that the fibre optic cable is positioned above the support member.

6. The method of claim 2 further comprising closing the conduit at both ends to avoid fluid and/or fine particle infiltration.

7. The method of claim 1, wherein burying comprises laying the fibre optic cable and the support member in the ground to form a winding path.

8. An apparatus for measuring in-ground vibration comprising:
a resilient support member having at least one cavity therein;
fibre optic cable attached to an external wall of the support member; and
a sensing unit for propagating light into the fibre optic cable, analysing the backscattered light from the fibre optic cable, and processing variations in the backscattered light to detect external movements.

9. The apparatus of claim 8, wherein the support member is made of soft PVC or rubber.

10. The apparatus of claim 8, wherein the resilient support member is a conduit.

11. The apparatus of claim 10, wherein the conduit is a tube having a shape selected from the following shapes: cylindrical, rectangular and elliptical.

12-16. (canceled)

17. The apparatus of claim 8 wherein the sensing unit comprises a phase-sensitive Optical Time Domain Reflectometer (OTDR) for light propagation in the fibre optic cable and analysis of light exiting the fibre optic cable.

18. A method for measuring in-ground vibration comprising:
propagating light into fibre optic cable attached to a resilient support member having at least one cavity therein,
analysing the backscattered light from the fibre optic cable, and
processing variations in the backscattered light to detect external movements.

19. The method of claim 18, wherein the resilient support member is a conduit.

20. The method of claim 18, wherein propagating light comprises emitting light from a laser source and directing the light in the fibre optic cable.

21. The method of claim 20, wherein propagating light comprises dividing the sensing cable length into a series of bins that have a width that is determined by a sampling rate of the controller.

22. The method of claim 21, wherein analysing the backscattered light comprises analysing the backscattered light from each of the series of bins.

23. The method of claim 18, wherein processing variations in the backscattered light comprises analysing the backscattered light to determine whether it contains any pattern that is a result of third party intrusion.

24. The method of claim 23 further comprising determining the location along the fibre optic cable of any pattern that is a result of third party intrusion.
